(19) United States
(12) Patent Application Publication
(10) Pub. No.: US 2005/0017861 A1
(43) Pub. Date: Jan. 27, 2005

(54) Turn signal physical alert system

(76) Inventor: Richard L. Hunter, San Jose, CA (US)

Correspondence Address: Richard L. Hunter, 1835 Via Cinco De Mayo, San Jose, CA, 95132, US

(21) Appl. No.: 10/626,804

(22) Filed: Jul. 25, 2003

(51) Int. Cl. B60Q 1/00

(52) U.S. Cl. 340/457

(57) ABSTRACT

The specification discloses a turn signal physical alert system. The alert is directed to a driver of a vehicle who inadvertently forget to turn the turn signal off. A turn signal can be left on and blinking in case of malfunction of the cancellation mechanism, in case the vehicle makes a turn of less than 90° or the person driving the vehicle is hearing impaired and does not hear the clicking sound of the system. The alert system consists of a time delay device which will activate a solenoid to vibrate against the seat on which the driver is sitting.

### CROSS REFERENCE TO RELATED APPLICATION

(none)

### STATEMENT REGARDING Fed R & D

(none)

### BACKGROUND OF THE INVENTION

The invention discloses a turn signal physical alert system. This system is very simple in construction and can easily be installed. As is well known, a turn signal is is a turn indicator whether a right turn or a left turn to be made by a driver of a vehicle. Also, as is well known, a turn signal indicates whether the driver of the vehicle intends to make a right or left turn into another street or intends to change the lane to either the left or the right lane. It is also well known that the turn signal lever cancels its engaged position once a turn has been made.

It also happens many times that the turn signal lever is not being canceled because the steering wheel has not been turned far enough in either direction to engage the canceling mechanism, which is located in the steering wheel column. In most cases the steering wheel has to be turned about 90° to activate the cancellation mechanism. This happens when the driver changes lanes because the steering wheel never turns more than 90°. It also can happen when the turn to be made into another street is a rather wide turn and the steering wheel therefore does not execute a turn of more than 90°.

If for any of the above reasons, the turn signal does not cancel, the continuing flashing of the turn signal light is rather annoying or disturbing for the driver following the vehicle having the turn signals on since that driver cannot comprehend the intentions of the driver ahead.

It is also well known that that turn signals, when engaged, make a clicking sound to remind the drive to turn the signal off.

In many instances the turn signal clicker is rather faint and cannot be heard. In other instances the road noise obscures the sound especially if the radio is on in the vehicle. Quite a few drivers are hearing impaired and can hear the clicker only very faintly or not at all. The clicker itself may be defective due to age and does not emit a very strong sound.

### BRIEF SUMMARY OF THE INVENTION

Because of all of the above, the applicant has created a system that will alleviate all of the above noted problems. The system includes a reminder to the driver that when a turn signal is left on and engaged, the driver will receive a physical alert that cannot be ignored. The physical alert is a tamping within the seat that is physically felt by the driver. It is also very possible to create an audible signal which is louder than the clicker sound coming from the turn signal system but this louder signal may not be enough to overcome the normal signal.

### BRIEF DESCRIPTION OF THE DRAWING

FIG. 1 is a top view of the schematic circuitry of the alert system.

### DETAILED DESCRIPTION OF THE INVENTION

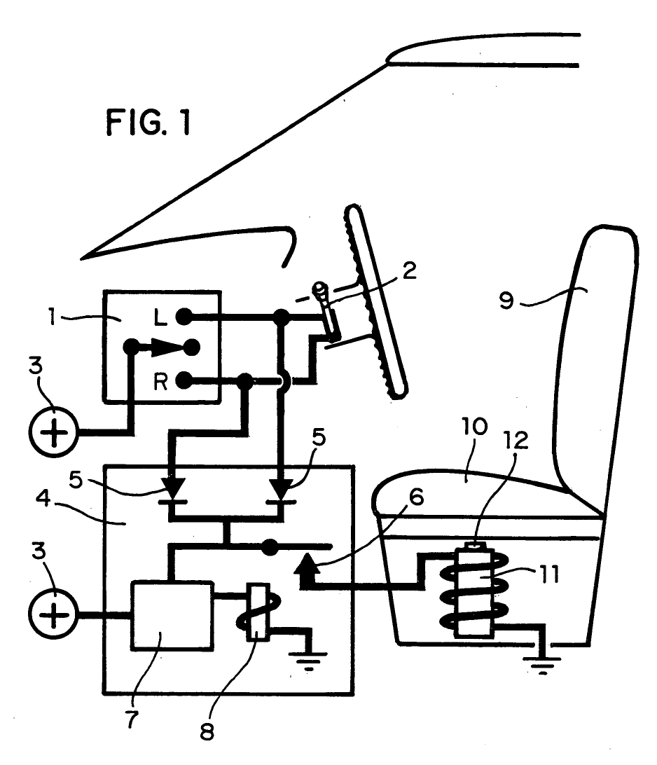

Referring to FIG. 1 there is shown the standard turn signal arrangement wherein 2 is the turn system lever and when turned on either activates the right R or the loft L turn signal flasher lights (not shown). When the turn signal is engaged it will activate a second timer and a transfer module 4. The steering wheel diodes 5 are applied to a 30 second circuit 7 by way of a transfer relay 6. At the end of a 30 second period the transfer relay 6 will operate to apply pulses to the driver's seat module 8. The pulses received in the cushion 10 of the driver's seat 9 will definitely alert the driver of a turn signal that needs to be turned off. That is, the tamper 12 of the vibrating solenoid 11 will vibrate against the cushion 10 on which the driver sits.

1. A turn signal system physical alert system adapted to alert a driver to a turn signal being engaged when not so demanded, said alert system including a turn signal switch operated by a turn signal lever, said turn signal switch being connected to a timer and transfer module including a connection to a counter, said counter activating a solenoid after a time delay to indicate to the said driver a physical signal to indicate that said turn signal is in an engaged position.

2. The turn signal system of claim 1, wherein said solenoid undergoes a vibrating motion.

3. The turn signal system of claim 2, wherein said vibrating motion is directed against an underside of a seat for said driver.
